(19) United States
(12) Patent Application Publication
(10) Pub. No.: US 2006/0085621 A1
(43) Pub. Date: Apr. 20, 2006

(54) Storage control apparatus and storage control method

(76) Inventors: Masaru Tsukada, Odawara (JP); Yoshihiro Asaka, Odawara (JP); Hidetoshi Sakaki, Odawara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/009,033

(22) Filed: Dec. 13, 2004

(30) Foreign Application Priority Data
Oct. 20, 2004 (JP) 2004-305776

(51) Int. Cl. G06F 12/10

(52) U.S. Cl. 711/202

(57) ABSTRACT

A storage control apparatus (20) is connected to a host apparatus (10) and to an external storage control apparatus (40) having an external storage device (42). The external storage control apparatus (40) stores address information representing at least either one of an external address which is an address of the external storage device, and an internal address which is an address of an internal storage device set in the storage control apparatus. The storage control apparatus receives address information from the external storage control apparatus, and based on the address information, generates address association information (3) representing the association between an internal address and an external address, and, when a write/read command which has as the access target the internal address is received from the host apparatus, by referencing the address association information, identifies the external address associated with the internal address, and accesses the identified external address.

### CROSS-REFERENCE TO PRIOR APPLICATION

This application relates to and claims priority from Japanese Patent Application No. 2004-305776, filed on Oct. 20, 2004, the entire disclosure of which is incorporated herein by reference.

### BACKGROUND OF THE INVENTION

1. Field of the Invention

This invention relates to a storage control apparatus connected to an external storage control apparatus, and to a storage control method realized in this storage control apparatus.

2. Description of the Related Art

As disclosed for example in Japanese Patent Laid-open No. 2004-5370, technology is known for constructing a single storage system comprising a storage control apparatus and an external storage control apparatus, in which the external storage control apparatus is connected to the storage control apparatus. Specifically, a host computer and first storage control apparatus may for example be connected via a first communication path, and the first storage control apparatus connected to a second storage control apparatus via a second communication path. The first storage control apparatus, upon receiving a first data input/output request from the host computer via the first communication path, and judging that the first data input/output request is not its own responsibility, transmits to the second storage control apparatus via the second communication means a second data input/output request corresponding to the first data input/output request. In this case, the second storage control apparatus receives the second data input/output request and executes data input/output processing corresponding to the request.

### SUMMARY OF THE INVENTION

Using technology of this kind, when for example a malfunction occurs in the second storage control apparatus, operations are performed to disconnect the second storage control apparatus from the first storage control apparatus and to connect another second storage control apparatus to the first storage control apparatus. If such a restoration operation can be easily performed, there is greater convenience for the user (for example, the manager of the first storage control apparatus).

Hence one object of this invention is to enable the easy construction of a storage system comprising a storage control apparatus and an external storage control apparatus.

Other objects of the invention will become clear through the following explanations.

The storage control apparatus of a first perspective of this invention can be connected to a host apparatus, which transmits write/read commands which are either write commands or read commands, and to an external storage control apparatus having an external storage device. The above external storage control apparatus stores address information representing at least either one of an external address, which is an address of the above external storage device, and an internal address, which is an address of an internal storage device set in the above storage control apparatus, and moreover transmits the above stored address information to the above storage control apparatus. The above storage control apparatus comprises a storage resource and a control portion. The above control portion receives the above address information from the above external storage control apparatus, and based on the above received address information, generates, in the above storage resource, address association information representing the association between an internal address and an external address. Further, the above control portion receives the above write/read commands from the above host device, and by referencing the address association information in the above storage resource, identifies the external address associated with the above internal address, and when the access target according to the above write/read command is the above associated internal address, writes the data to the above identified external address, or reads data from the identified external address and transmits the data to the above host device.

The number of external storage control apparatuses connected to the storage control apparatus may be one, or may be two or more. Similarly, the number of existing external storage devices may be one, or may be two or more.

An “external storage device” may be, for example, a physical storage device, or a logical storage device. An “external storage control apparatus” may be, for example, a hard disk drive comprising hard disks, or may be a disk array apparatus comprising a plurality of physical storage devices.

An “internal storage device” may be a storage device with a physical presence, such as for example a physical storage device or a logical storage device, or may be a virtual storage device with no physical presence. Specifically, in the case of a storage device with a physical presence, for example, the storage control apparatus can write data to the storage device, whereas in the case of a virtual storage device, data cannot be written to the virtual entity, but if an external storage device is associated with the virtual storage device, then data can be written to the external storage device.

A “control portion” may be a microprocessor, or may be a circuit board or similar comprising a microprocessor.

A “storage resource” may be a logical resource, or may be a physical resource. In the latter case, the storage resource may for example be memory or a hard disk.

A “storage control apparatus” may for example be a personal computer, or may be a storage control apparatus similar to an external storage control apparatus. The storage control apparatus need not necessarily comprise a storage device with a physical presence.

In a first aspect of this storage control apparatus, the above address information comprises internal address information which represents the above internal address, and is stored in the above external storage device. In this case, the above control portion receives address information read from the above external storage device, and generates address association information which represents the association between an external address of the above external storage device, and an internal address representing the internal address information within the above received address information.

In this first aspect, when there exist a plurality of external storage devices, address information may be stored in each of the storage devices, or a plurality of address information items may be stored in one external storage device. In the former case, the storage control apparatus can read the address information and associate the external address of the original external storage device and an internal address representing the internal address information comprised by the address information. On the other hand, in the latter case each of the plurality of address information items comprises, in addition to internal address information, external address information representing an external address associated with the internal address represented by the information item, and the storage control apparatus can associate the internal address and external address based on the external address information and the internal address information comprised by the received address information.

In a second aspect of a storage control apparatus, the above control apparatus can connect with one or more external storage control apparatuses. The above one or more external storage control apparatuses comprise a plurality of external storage devices. One external storage control apparatus may comprise a plurality of external storage devices, or each of a plurality of external storage control apparatuses may comprise at least one external storage control device. The above storage resource stores internal device information representing a plurality of internal addresses respectively corresponding to a plurality of storage devices. In this case, the above control portion inputs and writes to the above storage resource external device information to specify a plurality of external addresses corresponding respectively to the plurality of external storage devices. External device information may for example be input manually by a user, or may be received as a response to a specific command transmitted to the external storage control apparatus. The above control portion stores, in the above storage resource, information indicating which of the above plurality of external addresses are unassociated external addresses which have not yet been associated with internal addresses, based on the above external device information and the above address information. And, the above control portion stores, in the above storage resource, information indicating which of the above plurality of internal addresses are unassociated internal addresses which have not yet been associated with external addresses, based on the above internal device information and the above address information. The above control portion, upon receiving from the above host apparatus a write/read request described above for which the access target is an unassociated internal address stored in the above storage resource, selects at least one external address from among the one or more unassociated external addresses stored in the above storage resource, and accesses the selected external address. The above control portion also generates, in the above storage resource, address association information representing the association between the above selected external address and the unassociated internal address which is the above access target.

In a third aspect of a storage control apparatus, the above storage control apparatus comprises an internal storage device with a physical presence. The above control portion, when associating internal addresses and external addresses based on the above received address information, if an internal address is an address in the above internal storage device with a physical presence, generates in the above storage resource device association information representing the association between the above internal storage device and the above external storage device. Further, based on the device association information generated in the above storage resource, the above control portion writes the data written in the above internal storage device with a physical presence to the external storage device associated with the above internal storage device with a physical presence, or, writes the data written in the above external storage device to the above internal storage device with a physical presence associated with the external storage device.

In a fourth aspect of a storage control apparatus, the above address information in the above third aspect comprises external storage capacity information representing the storage capacity of the above external storage device, and internal storage capacity information representing the storage capacity of the above internal storage device with a physical presence. In this case, when the external storage capacity information in the above received address information representing the storage capacity is equal to or greater than the storage capacity represented by the above internal storage capacity information, the above control portion generates the above device association information.

In a fifth aspect of a storage control apparatus, the above address information in the above third aspect comprises internal address information representing internal addresses. The above storage resource stores separate internal address information representing internal addresses of the above storage device with a physical presence. When the internal address information comprised by the above received address information does not agree with the above separate internal address information, the above control portion sets a virtual internal storage device, based on the above internal address information. The above control portion presents to the above host apparatus both the above set virtual internal storage device, and the above internal storage device with a physical presence, as internal storage devices of the above control apparatus.

In this fifth aspect, the above control portion for example writes internal addresses represented by the above non-matching internal address information to the storage resource, and moreover registers the storage device having the internal address in the storage resource as a virtual storage device. Information (such as internal addresses) relating to internal storage devices with a physical presence is also registered in the storage resource. The control portion presents to the host apparatus both virtual storage devices and internal storage devices with a physical presence as storage devices comprised by the storage control apparatus. In this case, the host apparatus can issue write/read commands to the storage devices thus presented. The above control portion, upon receiving a write/read command, if the access target is an internal storage device with a physical presence, can perform reading and writing of data to and from the internal storage device. Further, upon receiving a write/read command, if the access target is a virtual storage device not having a physical presence, the above storage control portion references the address association information and can perform data reading and writing to and from the external storage device associated with that storage device. If, despite the fact that the access target is a virtual storage device, there is no external storage device associated with that storage device, the above control portion can specify an external storage device which has not been associated, and can associate an external address of the specified external storage device with the above internal address of the virtual storage device.

In a sixth aspect of a storage control apparatus, the above address information comprises final access time information representing the time of the last access of at least either one of the external address and the internal address. The above control portion, upon writing data to the above specified external address, or upon reading data from the specified external address and transmitting the data to the above host apparatus, updates the final access time information comprised by the address information corresponding to the external address. The above control portion deletes the address association information corresponding to the address information for which the time represented by the above final access time information is oldest, among the above plurality of address association information items stored in the above storage resource.

In a seventh aspect of a storage control apparatus, the above address information comprises a plurality of internal address information items representing a plurality of internal addresses. The above control portion associates a plurality of internal addresses, respectively represented by a plurality of internal address information items in the above received address information, with the same external address, and generates address association information representing this association in the above storage resource.

In an eighth aspect of a storage control apparatus, the above external storage control apparatus stores a plurality of address information items comprising information representing the same internal address. The above control portion, upon receiving the above plurality of address information items, generates, in the above storage resource, address association information representing the association of the same internal address with the plurality of external addresses.

In a ninth aspect of a storage control apparatus, the above control portion judges whether an internal storage device or an external storage device is nearline storage, and if the judgment result is positive, generates address association information which represents the association between internal addresses of the internal storage device and external addresses of the external storage device.

In this ninth aspect, the control portion records in a storage resource whether, for example, each internal storage device is nearline storage or not. For example, the above control portion manages the access frequency (number of accesses per unit time) for each internal storage device, and when the access frequency is equal to or greater than a prescribed value, judges that the internal storage device is not nearline storage, but when the access frequency is less than the prescribed value, judges the internal storage device to be nearline storage, and based on this judgment result, can update the storage resource. Also, the above control portion can for example respond to a manual operation by a user (for example, based on input from a computer machine connected to the storage control apparatus) to set in the storage resource an internal storage device specified by the user as nearline storage. And, the above control portion may for example reference the data of the internal storage device or external storage device, and judge whether the internal storage device is nearline storage according to whether the data update frequency is equal to or greater than a prescribed value.

A method according to a second perspective of this invention is a storage control method realized in a storage control apparatus which can be connected to a host apparatus, which transmits write/read commands which are write commands or read commands, and to an external storage control apparatus having an external storage device. The above external storage control apparatus stores address information representing the address of at least either one of the external storage device, and an internal storage device set in the above storage control apparatus, and moreover transmits the above stored address information to the above control apparatus. In this case, the above storage control method has a step of receiving the above address information from the above external storage control apparatus; a step of generating, in the above storage resource, address association information representing the association between internal addresses and external addresses, based on the above received address information; a step of receiving the above write/read commands from the above host apparatus, and by referencing the address association information in the above storage resource, of specifying the external address associated with an internal address described above; and, a step, when the access target according to the above write/read command is an associated internal address as described above, of writing data to the above specified external address, or of reading data from the specified external address and transmitting the data to the above host apparatus.

The above-described storage control apparatus and storage control method can be applied to a mainframe storage system, and also to an open-systems type storage system.

### BRIEF DESCRIPTION OF THE DRAWINGS

FIG. 1 shows the configuration of a storage system of a first embodiment of the first aspect of the invention;

FIG. 2A shows an example of information stored in shared memory;

FIG. 2B shows an example of the configuration of a VOL management table;

FIG. 3 shows an example of the configuration of a mapping table;

FIG. 4A shows an example of the configuration of a certain external VOL;

FIG. 4B shows an example of the configuration of data for mapping;

FIG. 5 shows an example of a first flow of connection processing;

FIG. 6 shows an example of a first flow of data processing;

FIG. 7 shows a portion of an example of a second flow of connection processing;

FIG. 8 shows another portion of an example of the second flow of connection processing;

FIG. 9 shows an example of a second flow of data processing;

FIG. 10 shows a portion of a flow of connection processing in a second embodiment of the first aspect of the invention;

FIG. 11 shows a portion of a flow of data processing in the second embodiment of the first aspect of the invention;

FIG. 12 shows an example of the configuration of data for mapping in a third embodiment of the first aspect of the invention; and,

FIG. 13 shows an example of processing performed in a fourth embodiment of the first aspect of the invention.

### DESCRIPTION OF THE PREFERRED EMBODIMENTS

Below, a number of embodiments of a first aspect of the invention are explained, referring to the drawings.

### Embodiment 1

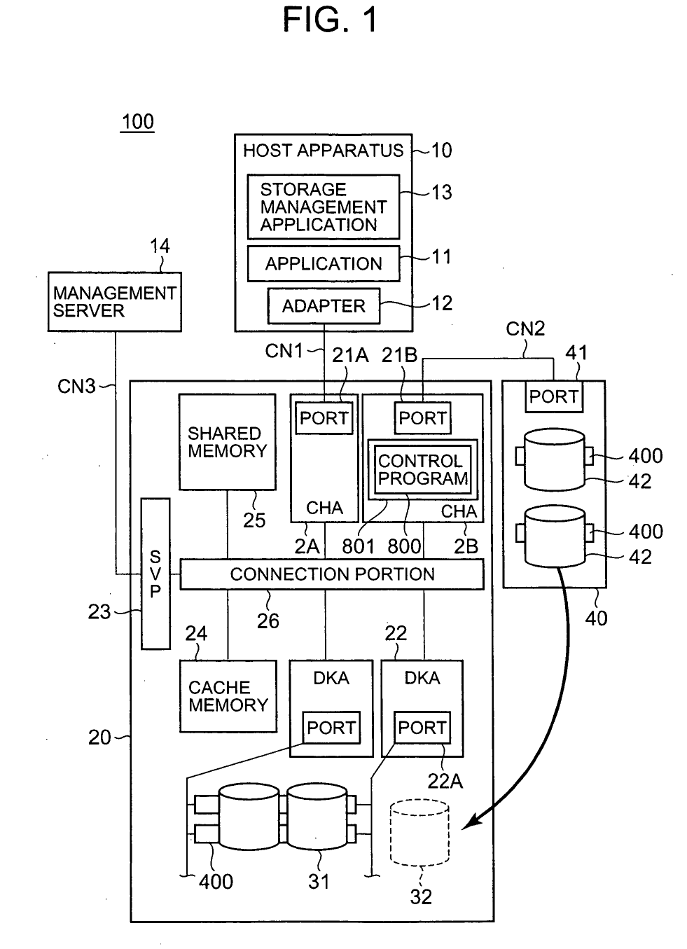

FIG. 1 shows the configuration of a storage system of a first embodiment of the first aspect of the invention. In the following explanation, the first storage control apparatus may simply be called the “storage control apparatus”, and the second storage control apparatus may be called the “external storage control apparatus”. In FIG. 1, the number of second storage control apparatuses 40 connected to the first storage control apparatus 20 is one; but a plurality of second storage control apparatuses 40 can be connected to the first storage control apparatus 20.

This storage system 100 further comprises a first storage control apparatus 20, which comprises one or more logical storage devices (also called logical volumes; hereafter abbreviated as “VOL”) 31, and a second storage control apparatus 40, comprising one or more VOLs 42.

The first storage control apparatus 20 is connected to the host apparatus 10 via a first communication network CN1, to the second storage control apparatus 40 via a second communication network CN2, and to a management server 14 via a third communication network CN3.

The host apparatus 10 is for example a computer apparatus comprising a CPU (Central Processing Unit), memory, and other information processing resources, and may for example be configured as a personal computer, workstation, mainframe, or similar. The host apparatus 10 comprises for example a keyboard switch, pointing device, microphone, or other information input devices (not shown), and for example a monitor display, speaker, or other information output devices (not shown). Further, the host apparatus 10 is provided with for example database software or another application program 11 which uses storage areas provided by the first storage control apparatus 20, and an adapter 12 to access the first storage control apparatus 20 via the first communication network CN1.

The host apparatus 10 comprises a storage management application 13. The storage management application 13 is a computer program which is read into and operates on a CPU, not shown, and outputs instructions (control data) to the first storage control apparatus 20 to control operation of the first storage control apparatus 20. Specifically, the storage management application 13 can for example select a copy source VOL 31 (or 32) and copy target VOL 31 (or 32) from among a plurality of VOLs 31 managed by the first storage control apparatus 20, and can cause the first storage control apparatus 20 to perform copying of data from the copy source to the copy target.

The host apparatus 10 can input and output data to and from the first storage control apparatus 20 via the first communication network CN1. The host apparatus 10 can be, for example, a mainframe computer machine. The host apparatus 10 can perform communications according to, for example, FICON (Fibre Connection, a registered trademark), ESCON (Enterprise System Connection, a registered trademark), ACONARC (Advanced Connection Architecture, a registered trademark), FIBARC (Fibre Connection Architecture, a registered trademark), or another communication protocol.

The first storage control apparatus 20 is configured as for example a disk array subsystem. However, the first storage control apparatus 20 is not limited to this, and can be configured as a highly functional intelligent-type fiber channel switch. The same is true of the second storage control apparatus 40.

The first storage control apparatus 20 comprises a controller portion and one or a plurality of physical storage devices 400. The controller portion comprises, for example, a plurality of (for example, two) channel adapters (CHAs) 2A, 2B, a plurality of disk adapters (DKAs) 22, a service processor (SVP) 23, cache memory 24, shared memory 25, and a connection portion 26.

The CHAs 2A, 2B perform data communication with external equipment (for example, the host apparatus 10 or the second storage control apparatus 40) connected to the first storage control apparatus 20. The CHA 2A and 2B comprise communication ports 21A, 21B to perform communication with external equipment. In this embodiment, the CHA 2A is connected to the host apparatus 10 via the communication port 21A and first communication network CN1, and the CHA 2B is connected to the second storage control apparatus 40 via the communication port 21B and second communication network CN2. The CHAs 2A and 2B are each configured as microcomputer systems comprising, for example, an MP (Micro Processor) 801, memory and similar, and interpret and execute various commands received from external equipment. For example, network addresses for identification are allocated to the CHAs 2A and 2B. Also, the CHAs 2A and 2B can operate by means of a control program 800 which is read and executed by the MP 801. This control program 800 can for example perform connection processing and data processing, described below.

Each DKA 22 exchanges data with a physical storage device 400. Each DKA 22 comprises a communication port 22A for connection to the physical storage device 400. Further, each DKA 22 is configured as a microcomputer system comprising a CPU, memory and similar. Each DKA 22 writes data to the physical storage device 400 and reads data from the physical storage device 400, according to instructions from the CHAs 2A and 2B. When performing data input/output with the physical storage device 400, each DKA 22 converts a logical address into a physical address. When the physical storage device 400 is managed as a RAID system, each DKA 22 accesses data according to the RAID configuration.

The SVP 23 is a computer apparatus, operated for purposes of maintenance or management of the first storage control apparatus 20, and is for example a notebook-type personal computer. The SVP 23 can monitor fault occurrences in the apparatus 20 and displays the results on a display screen (not shown), and can specify blockage processing and similar of physical storage devices (for example, hard disk drives) comprising a VOL 31, based on an instruction from the storage management application. The SVP 23 is connected to the management server 14 via the third communication network CN3. The SVP 23 can receive data or commands from the management server 14 via the third communication network CN3.

The cache memory 24 temporarily stores data received from the host apparatus 10, data read from a VOL 31, and similar. Information used to control operation of the first storage control apparatus 20, information representing the association relation between the various VOLs 31 and the physical storage devices 400, and similar are stored in shared memory 25. The cache memory 24 and shared memory 25 may be provided as separate memory, as in the drawing, or may be provided as logically divided portions in the same [physical] memory.

The connection portion 26 connects each of the CHAs 21, each of the DKAs 22, the SVP 23, cache memory 24, and shared memory 25 to each other. The connection portion 26 can for example be configured as an ultra-high speed crossbar switch or other high-speed bus to perform data transmission through high-speed switching operation. Configuration as a LAN, SAN, or other communication network is also possible, as is configuration of a plurality of networks in addition to the above-described high-speed bus.

As physical storage devices 400, for example, hard disks, flexible disks, magnetic tape, semiconductor memory, optical discs, or other devices can be used. One or more VOLs 31 can be prepared on one or a plurality of physical storage devices 400. Below, in order to aid understanding of the explanation, a VOL 31 comprised by the first storage control apparatus 20 is called the “internal VOL 31”, and a VOL 42 comprised by the second storage control apparatus 40 may be called the “external VOL 42”.

The reference number 32 indicated by a dotted line in FIG. 1 is a virtual internal VOL provided to the host apparatus 10 (or to the management server 14). In other words, the reference number 32 indicates the state in which the external VOL 42 of the second storage control apparatus 40 is virtually incorporated into the first storage control apparatus 20. That is, in this embodiment the VOL 42 which exists outside as seen from the first storage control apparatus 20 is presented to the host apparatus 10 (or to the management server 14) as a VOL 32 comprised within the first storage control apparatus 20. In other words, the first storage control apparatus 20 presents the VOL 42 of the second storage control apparatus 40 to the host apparatus 10 as its own VOL 32, so that the VOL need not be a local VOL 31 directly managed by the apparatus (that is, a physical storage device 400 needed to comprise the VOL 31). That is, the first storage control apparatus 20 can present storage resources to the host apparatus 10, even when not comprising any VOLs 31.

The second storage control apparatus 40 can be configured similarly to the first storage control apparatus 20. For example, the second storage control apparatus 40 may comprise a communication port 41 and VOL 42, and may in addition comprise a CHA, DKA, and similar. The second storage control apparatus 40 is connected to the first storage control apparatus 20 via the second communication network CN2, and an external VOL 42 is handled as an internal VOL 32 of the first storage control apparatus 20.

The above summarizes a storage system 100 of this embodiment. The first storage control apparatus 20 manages, in shared memory 25 (or in cache memory 24), which of the plurality of internal VOLs is an internal VOL 31 with a physical presence, and which is a virtual internal VOL 32 without a physical presence. The CHA 2A, upon receiving an I/O request (input/output request, for example a write command or a read command) for a certain internal VOL 31, causes the DKA 22A to access that certain internal VOL 31. And upon receiving an I/O request for a certain virtual internal VOL 32, the CHA 2A specifies the external VOL 42 associated with the virtual internal VOL 32, and causes the CHA 2B to access the specified external VOL 42.

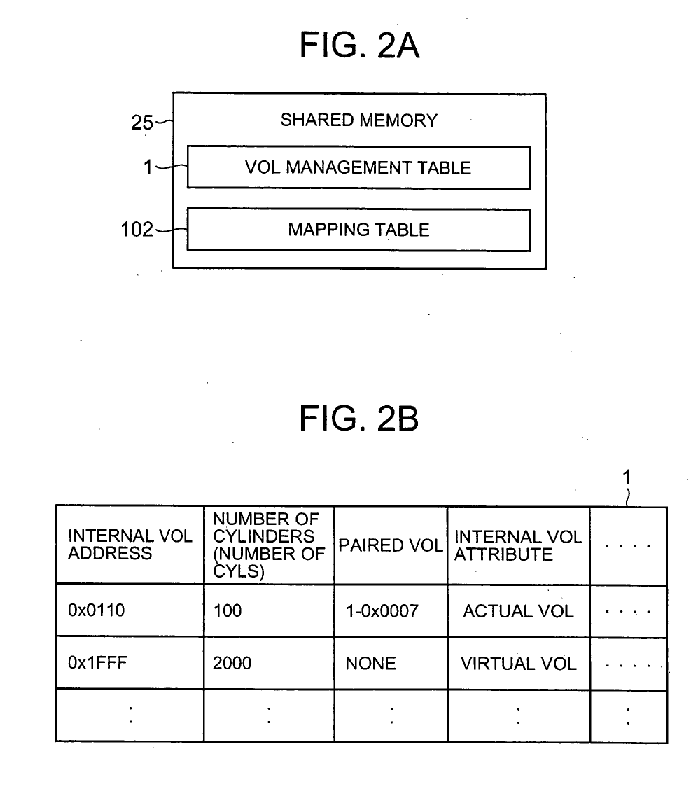

FIG. 2A shows an example of information stored in shared memory 25.

The shared memory 25 stores, for example, a VOL management table 1 to manage VOLs, and a mapping table 102 for management of the association between internal VOLs and external VOLs.

FIG. 2B shows an example of the configuration of a VOL management table.

Information related to internal VOLs is registered in the VOL management table 1. Specifically, for example, for each internal VOL, an internal VOL address, number of cylinders, paired VOL, and internal VOL attributes are registered.

An internal VOL address is information relating to the address of the internal VOL, and may be, for example, information comprising the cylinder head number and record number. The cylinder head number is a number representing the cylinder position; the record number is a number representing the position within the cylinder to be accessed. Each VOL is a collection of cylinders. A cylinder is a portion of a VOL, resulting from logical division of the VOL. The storage capacity of each VOL differs depending on the number of cylinders comprised by the VOL. The cylinder storage size may be either a prescribed size or an arbitrary size, but in this embodiment is a prescribed size. The cylinder size can for example be stored in shared memory 25.

The number of cylinders is the number of cylinders comprised by the internal VOL.

The paired VOL represents the VOL (another internal VOL, or an external VOL) which is paired in association with the internal VOL. When there does not exist a VOL paired with the internal VOL, information indicating this fact (for example, “none”) is registered. When the paired VOL is an external VOL, the paired VOL information can be represented by a combination of the address of the external VOL, and the ID of the second storage control apparatus comprising the external VOL.

The internal VOL attributes are information representing the type of the internal VOL. Internal VOL attributes may be, for example, “actual VOL”, indicating an internal VOL 31 with a physical presence, and “virtual VOL”, indicating a virtual internal VOL 32 without a physical presence.

The above is an example of the configuration of a VOL management table 1. Information items registered in the VOL management table 1 are not limited to that described above, and may for example be more numerous or less numerous than the items described above.

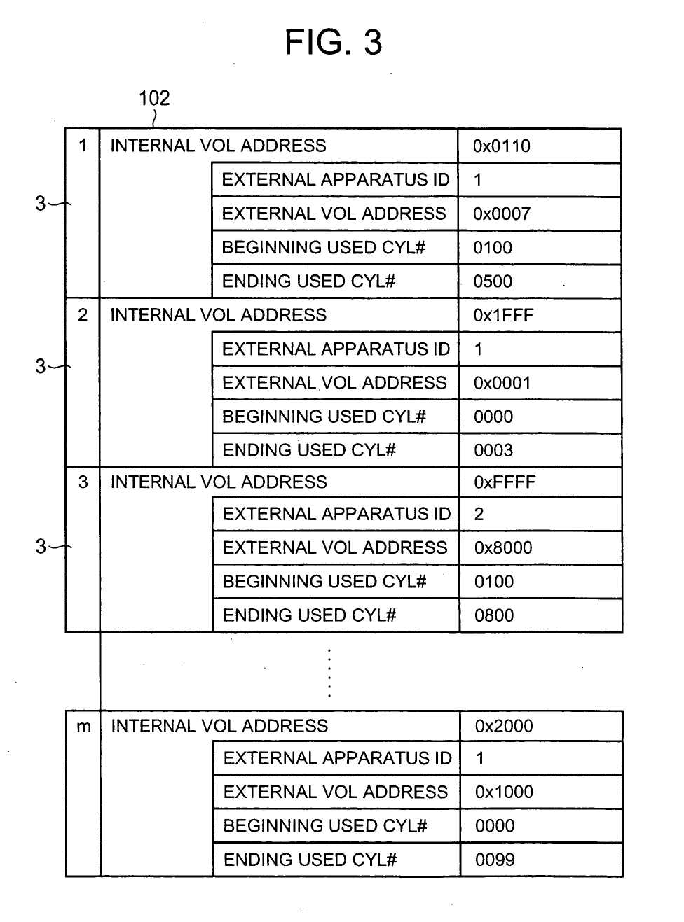

FIG. 3 shows an example of the configuration of a mapping table 102.

As described above, the mapping table 102 is a table used to manage the association between internal VOLs and external VOLs. The mapping table 102 comprises, for example, one or more address association records 3. Each address association record 3 comprises internal address data which is data relating to the address of the internal VOL, and external address data which is data relating to the address of the external VOL. The internal address data may for example be the above-described internal VOL address. The external address data may for example be a data element (below, an external apparatus ID) to identify the second storage control apparatus 40 which is the connection target, the external VOL address of the external VOL 42 comprised by the second storage control apparatus 40, a data element representing the beginning and end of the area used by the external VOL 42 (for example, a number representing the beginning cylinder of the area used (hereafter, the beginning used CYL#), and a number representing the ending cylinder of the area used (hereafter, the ending used CYL#)).

The first storage control apparatus 20 (that is, the microprocessors of the CHA 2A and 2B) can thus, by referencing the mapping table 102, specify which internal VOL is associated with which external VOL 42 of which second storage control apparatus 40.

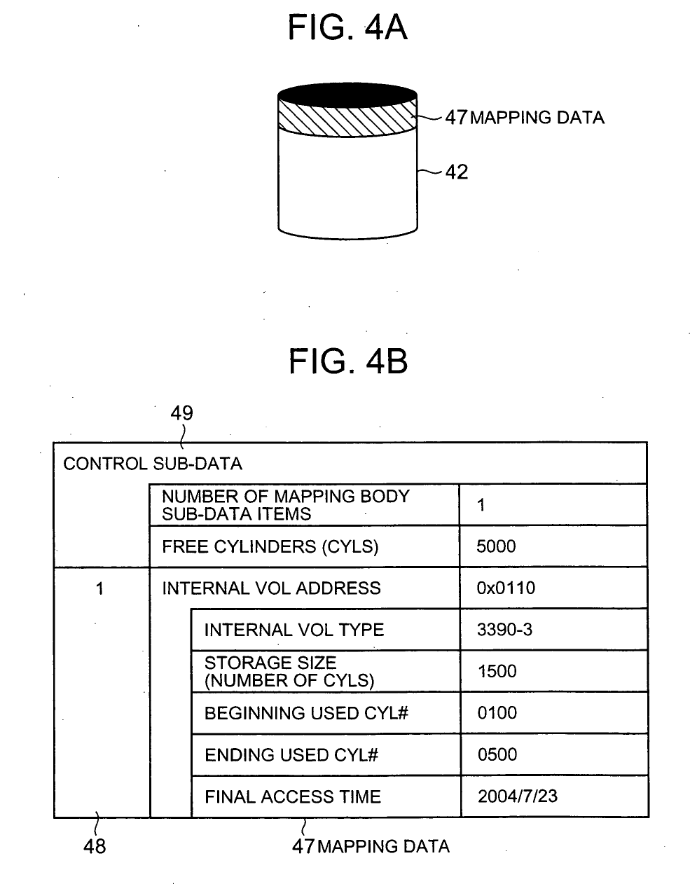

FIG. 4A shows an example of the configuration of a certain external VOL. FIG. 4B shows an example of the configuration of data for mapping.

In addition to data transmitted from the host apparatus 10 for writing, mapping data 47 can also be stored in the external VOL 42. Mapping data 47 is data used to generate address association records 3 in the mapping table 102.

Mapping data 47 comprises control sub-data 49, and one or more mapping body sub-data items 48.

In the control sub-data 49 are recorded the number of mapping body sub-data items, which represents the number of mapping body sub-data items 48 in the mapping data 47, and the number of free cylinders in the external VOL 42 storing the mapping data 47.

Mapping body sub-data 48 is sub-data used to generate address association records 3 in the mapping table 102. Mapping body sub-data 48 comprises, for example, an internal VOL address, the type of the internal VOL, and the storage size of the internal VOL (in this embodiment, the number of cylinders). The mapping body sub-data 48 comprises sub-data elements (for example, the beginning used CYL# and the ending used CYL#) representing the beginning and end of the used area in the external VOL 42 in which is stored the mapping data 47, and a final access time representing the time at which the external VOL 42 was last accessed. When data is written to the external VOL 42 which stores this mapping data 47, at least one among the beginning used CYL#, ending used CYL#, and final access time is updated by the CHA 2B of the first storage control apparatus 20, or by a CHA, not shown, of the second storage control apparatus 40.

The above is an example of the configuration of mapping data 47. In the example of FIG. 4B, the number of mapping body sub-data items 48 is one; when the number is two or more, the number of mapping body sub-data items in the control sub-data 49 will be two or more, and in addition two or more mapping body sub-data items 48 will be comprised within the same mapping data 47. The mapping data 47 may be stored in any location of the second storage control apparatus 40. For example, in this embodiment one mapping data item 47 is stored in one external VOL 42, but this need not be the case. Specifically, an external VOL may for instance be prepared for storage of mapping data 47, and a plurality of mapping data items 47 stored in the external VOL. In this case, each mapping data item 47 may comprise, in addition to an internal VOL address, an external VOL address associated with the internal VOL address. Further, one or a plurality of mapping data items 47 may be stored in memory, not shown (for example, in shared memory or in cache memory), of the second storage control apparatus 40.

The first storage control apparatus 20 (for example, a control program 800 read into the microprocessor 801 of the CHA 2B) can perform the connection processing and data processing explained below. In the following each of these processing flows is explained.

(A) First Connection Processing

This first connection processing can be executed when for example there exist no internal VOLs 31 with a physical presence in the first storage control apparatus 20, or when, even if such exist, there exists no internal VOL address which is the same as the internal VOL address of the internal VOL 31 in the mapping data 47 received from the second storage control apparatus 40.

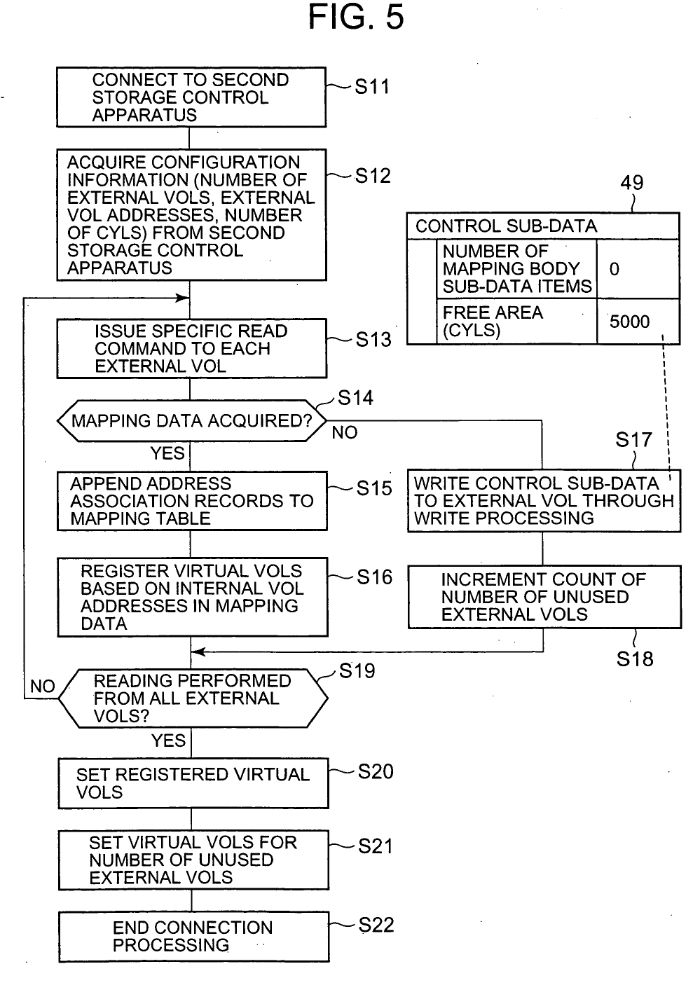

FIG. 5 shows an example of the first flow of connection processing.

The CHA 2B, upon connection to the second storage control apparatus 40 (step S11), issues a prescribed inquiry command to the second storage control apparatus 40 via the second communication network CN2. The second storage control apparatus 40 (for example, a CHA not shown), in response to this inquiry command, references a VOL management table (a table similar to the table 1 in FIG. 2B) stored in memory not shown (for example, shared memory), and based on this VOL management table, generates configuration information for the second storage control apparatus 40 and transmits the generated configuration information to the CHA 2B. By this means the CHA 2B acquires configuration information relating to the connected second storage control apparatus 40 (S12). This configuration information may also be prepared in a prescribed storage area of the second storage control apparatus 40. The configuration information comprises, for example, the number of external VOLs 42 comprised by the second storage control apparatus 40, and the external VOL address and number of cylinders of each external VOL 42. The CHA 2B accumulates the acquired configuration information in a storage area (for example, memory held by the CHA itself, not shown, or shared memory 25) within the first storage control apparatus 20.

The CHA 2B can ascertain, from the configuration information acquired in S12, the one or more external VOLs 42 existing within the connected second storage control apparatus 40. The CHA 2B issues a specific read command to a certain external VOL among the one or more external VOLs 42 thus ascertained (S13). The specific read command is a command to read mapping data 47 which should exist in an external VOL. Upon receiving this command, if mapping data 47 exists in the specified external VOL, the second storage control apparatus 40 reads and returns the mapping data, and if the mapping data does not exist in the external VOL, returns information to this effect. In a case in which the mapping data 47 is written continuously, for example, from a prescribed cylinder (for example, the beginning cylinder) of the external VOL 42 to another prescribed cylinder (for example, the ending cylinder), by issuing a read command specifying the prescribed cylinder, the mapping data 47 which has been written beginning from this prescribed cylinder can be acquired.

When mapping data 47 is received (YES in S14), the CHA 2B generates an address association record 3 based on the mapping body sub-data 48 comprised by the received mapping data 47, and appends the generated address association record 3 to the mapping table 102 (S15). Specifically, by for example associating the ID of the connected second storage control apparatus 40, the external address of the external VOL 42 which is the read source of the mapping data 47, and the beginning used CYL# and ending used CYL# comprised by the mapping body sub-data 48, with an internal VOL address comprised by the mapping body sub-data 48, the CHA 2B generates an address association record 3. When a plurality of mapping body sub-data items 48 are comprised, the CHA 2B can associate the external VOL 42 which is the above read source with a plurality of internal VOL addresses comprised by the respective plurality of mapping body sub-data items 48.

The CHA 2B registers a virtual VOL, based on the internal VOL address comprised by the acquired mapping body sub-data 48 (S16). Specifically, for example, the CHA 2B writes the internal VOL address comprised by the acquired mapping body sub-data 48 to a prescribed storage area (for example, shared memory 25).

In S14, if mapping data 47 could not be acquired (NO in S14), the CHA 2B writes control sub-data 49 to the external VOL 42 through write processing (for example, by using a write command to the external VOL) for the external VOL which is the target to which the read command of S13 was issued (S17). Specifically, the CHA 2B for example generates control sub-data 49 comprising the number of mapping body sub-data items, which is “0”, and the number of free cylinders in the external VOL 42 (the number of specified cylinders from the configuration information acquired in S12), and writes the generated control sub-data 49 to the external VOL 42. By this means, incomplete mapping data, in which control sub-data 49 exists but mapping body sub-data 48 does not exist, is stored in the external VOL 42.

When performing the processing of S17, the CHA 2B increments the count of the number of unused external VOLs (S18). The count value of the number of unused external VOLs is stored in a prescribed storage area, such as for example a register comprised by the CHA 2B or in memory, not shown. The CHA 2B can also register an external VOL address of the external VOL 42 (an address specified by the configuration information acquired in S12) as an unused external VOL address in a prescribed storage area (for example, memory in the CHA 2B, not shown, or shared memory 25).

The CHA 2B performs the processing of S13 through S18 for all external VOLs 42 specified by the configuration information acquired in S12 (NO in S19).

When the CHA 2B has performed the processing of S13 through S18 for all the external VOLs 42 (YES in S19), the virtual VOLs registered in S16 are set (S20). Specifically, for example, the CHA 2B appends the internal VOL addresses registered in shared memory 25 to the VOL management table 1, and moreover registers “virtual VOL” as the internal VOL attributes corresponding to the internal VOL addresses.

Further, the CHA 2B newly sets the same number of virtual VOLs as there are unused external VOLs (S21). Specifically, for example, the CHA 2B follows prescribed rules to generate internal VOL addresses in the same number as the number of unused external VOLs, and based on these internal VOL addresses, sets virtual VOLs by a method similar to that of S20.

When the setting of virtual VOLs registered in S16 and the setting of the same number of virtual VOLs as the number of unused external VOLs is completed, connection processing ends (S22).

The above is the first flow of connection processing. The second storage control apparatus 40, upon being connected to the first storage control apparatus 20 in S11, may transmit configuration information and mapping data for external VOLs without receiving an inquiry command or read command from the first storage control apparatus 20.

(B) First Data Processing

This first data processing can be executed, for example, after the first connection processing explained in FIG. 5, when an I/O request is received from the host apparatus.

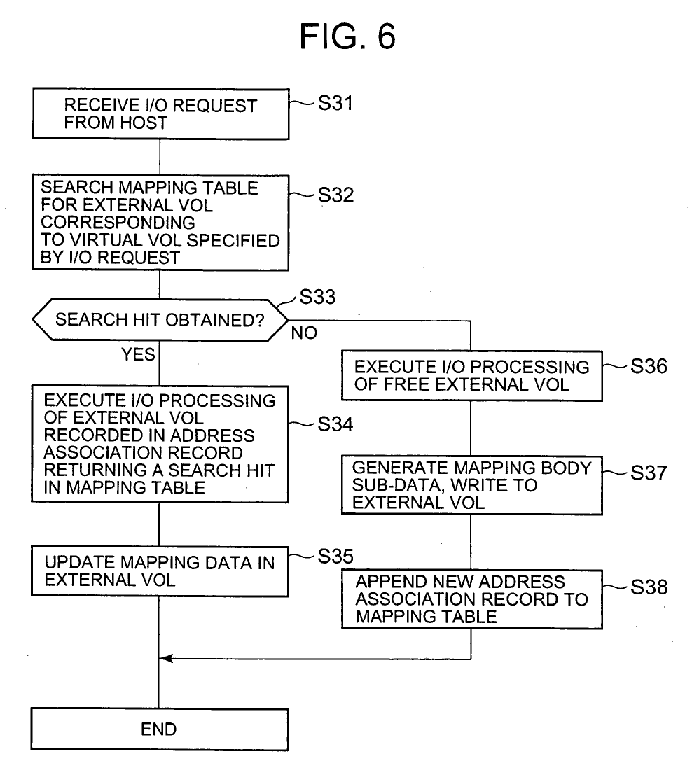

FIG. 6 shows an example of the first flow of data processing.

Upon receiving an I/O request from the host apparatus (S31), the CHA 2A searches the mapping table 102 for the VOL address corresponding to the internal VOL address (here, the virtual VOL address) specified by the I/O request (S32).

When this search results in a hit (YES in S33), the CHA 2A identifies the external VOL address and external apparatus ID from the address association record 3 in the mapping table 102 resulting in the search hit, and commands the CHA 2B connected to the second storage control apparatus 40 to execute I/O processing (data writing or reading) of the external VOL address (identified external VOL address) of the second storage control apparatus 40 associated with the identified external apparatus ID. Specifically, for example, the CHA 2A writes a command to this effect in shared memory 25, and CHA 2B acquires this command. In response to the command from the CHA 2A, CHA 2B executes I/O processing of the above identified external VOL address (S34). The CHA 2B updates the mapping data within the external VOL associated with the external VOL address (S35). Specifically, for example, the CHA 2B updates the beginning used CYL# and ending used CYL# of the mapping body sub-data 48 comprising the internal VOL address in S32.

When there is no search hit in S33 (NO in S33), the CHA 2A commands the CHA 2B connected to the second storage control apparatus 40 having an external VOL address, selected from among one or more unused external VOL addresses (for example, registered addresses in S18), to execute I/O processing for the external VOL address, and by this means executes I/O processing of the external VOL address (S36). Information on which CHA 2B is connected to which second storage control apparatus 40 is for example stored in shared memory 25, and by referencing the shared memory 25, the CHA 2A can identify the CHA 2B to which the command is to be issued.

Based on the number of the cylinder used in I/O processing, the access time for the above external VOL address selected in I/O processing, and the internal VOL address in S32, the CHA 2B generates mapping body sub-data 48 and writes the generated mapping body sub-data 48 to the external VOL having the above selected external VOL address (S37). At this time, the CHA 2B creates mapping data 47 from the control sub-data 49 written in S17 of FIG. 5 and the mapping body sub-data 48. Specifically, for example, the CHA 2B begins to write the mapping body sub-data 48 from the cylinder having the cylinder number after the cylinder number to which control sub-data 49 was written.

Based on the mapping body sub-data 48 generated in S37, the CHA 2B generates an address association record 3 by a method similar to that of S15 in FIG. 5, and appends the generated address association record 3 to the mapping table 102 (S38).

The above is the first data processing flow. In this processing, when in S32 the internal VOL address specified by the I/O request is an address in an internal VOL 31 with a physical presence, and moreover there were no search hits in S33, the CHA 2A may command the DKA 22 to access the address in the internal VOL 31.

(C) Second Connection Processing

This connection processing can for example be executed when an internal VOL 31 with a physical presence exists in the first storage control apparatus 20.

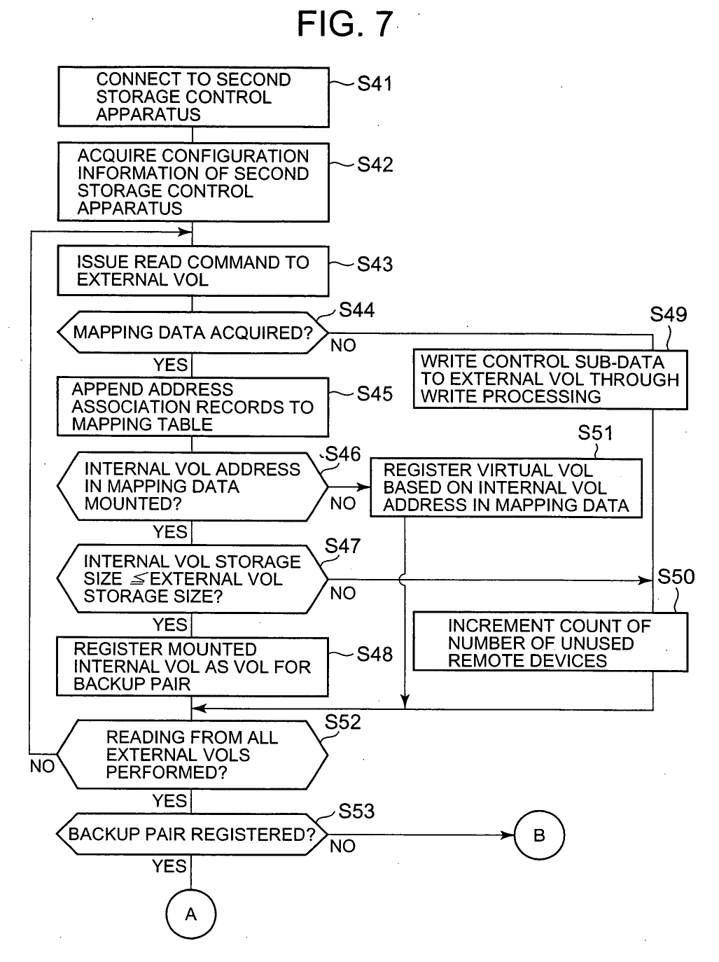

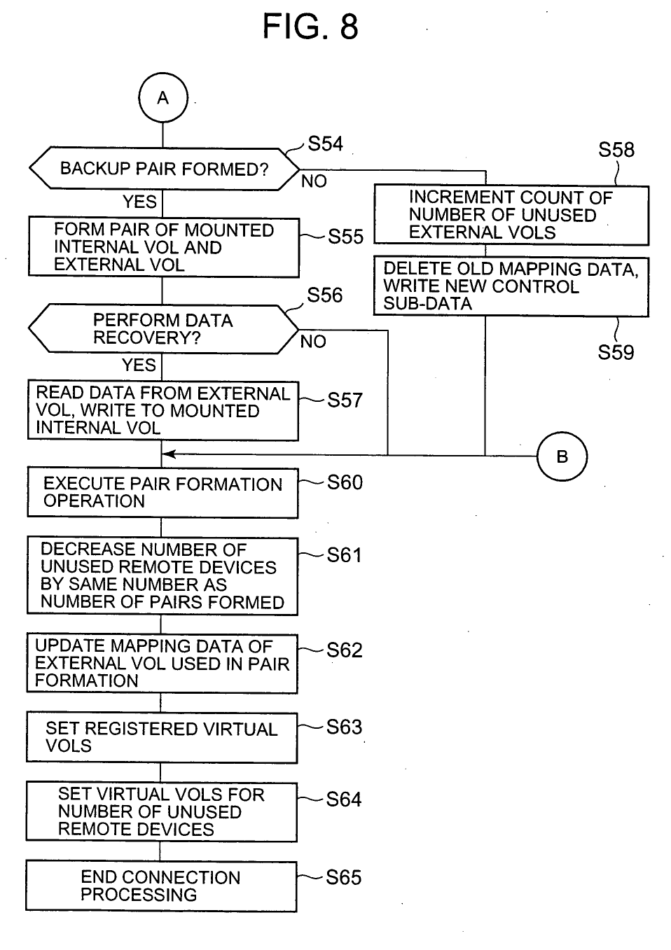

FIG. 7 shows a portion of an example of the second flow of connection processing, and FIG. 8 shows another portion of the example of the second flow of connection processing. FIG. 7 and FIG. 8 can be concatenated to obtain an example of the second flow of connection processing.

In the second connection processing, processing similar to that of S11 through S14 in FIG. 5 is performed (S41 through S44). When the result is NO in S44, the processing of S17 through S19 in FIG. 5 is performed (S49, S50 and S52).

When the result is YES in S44, similarly to S15, an address association record is appended to the mapping table 102 (S45), and a judgment is performed as to whether the internal VOL address in each mapping body sub-data item 48 in the acquired mapping data 47 is mounted (S46). Whether an address is mounted or not can be judged by whether, for example, the internal VOL address is registered in the VOL management table 1, and moreover the internal VOL attribute associated with the internal VOL address is “actual VOL”.

When the judgment result of S46 is negative (NO in S46), the CHA 2B registers a virtual VOL based on the internal VOL address in the mapping body sub-data 48 (S51). Specifically, for example, the CHA 2B stores information in a prescribed storage area of shared memory 25 indicating that the internal VOL address is [in a] virtual VOL.

When the judgment result of S46 is positive (YES in S46), the CHA 2B compares the internal VOL storage size in the mapping body sub-data 48 in the acquired mapping data 47, and the free storage size in the control sub-data 49 in the acquired mapping data 47 (S47).

If as the result of the comparison in S47 the free storage size is less than the internal VOL storage size (NO in S47), the CHA 2B takes the external VOL in which the acquired mapping data 47 had been stored to be an unused external VOL, and executes S50. In this case, the CHA 2B may delete the address association record which had been appended in S45.

If as the result of the comparison in S47 the free storage size is equal to or greater than the internal VOL storage size (YES in S47), the CHA 2B registers the internal VOL judged to be mounted in S46 as a backup pair VOL (S48). Specifically, for example, the CHA 2B stores, in shared memory 25 or some other prescribed storage area, information indicating that the internal VOL address of the mounted internal VOL is a backup VOL (in other words, is paired with the external VOL which is the read source of the mapping data 47).

If the result in S52 is YES, processing proceeds to S53, and the CHA 2B judges whether the backup pair has been registered (S53).

If the judgement result in S53 is negative (NO in S53), the CHA 2B executes the processing of S60, described below.

If the judgment result in S53 is positive (YES in S53), the CHA 2B judges whether to form a backup pair (S54). This judgment can be performed for example according to whether there has been input from the management server 14 or SVP 23 to form a backup pair with the mounted internal VOL registered in S48.

If the judgment result in S54 is negative (NO in S54), CHA 2B increments the count of the number of unused external VOLs (S58), deletes the mapping data 47 from the above read-source external VOL 42, and moreover generates new control sub-data 49 and writes this control sub-data 49 to the external VOL 42 (S59). The written control sub-data 49 can for example be generated by a method similar to that of S17 in FIG. 5. Then, the CHA 2B executes the processing of S60, described below.

If the judgment result in S54 is positive (YES in S54), the CHA 2B forms a pair from the mounted internal VOL and the above read-source external VOL (S55). Specifically, for example, the CHA 2B writes, in the field for the pair-corresponding to the mounted internal VOL and the internal VOL address in the VOL management table 1, the read-source external VOL address and the external apparatus ID of the second storage control apparatus 40 which has the external VOL.

After S55, the CHA 2B judges whether to perform data recovery (S56). This judgment can for example be performed according to whether input has been received from the management server 14 or SVP 23 to perform data recovery.

If the judgment result in S56 is negative (NO in S56), the CHA 2B executes the processing of S60, described below.

If the judgment result in S56 is positive (YES in S56), the CHA 2B reads data (for example, data other than the mapping data 47) from the external VOL 42 with which a pair was formed in S55, and writes the data thus read to the mounted internal VOL 31 with which the pair was formed (S57). By this means, a backup of the external VOL 42 is created in the mounted internal VOL 31.

After S57 (NO in S53, NO in S56 and S59), S60 can be executed.

In S60, a pair formation operation is executed. Here, for example, the CHA 2B forms a pair between an unused external VOL and an internal VOL for which a paired VOL does not exist, based on input from the SVP 23 or the management server 14. The CHA 2B then decreases the number of unused external VOLs by the number of pairs formed (S61). The CHA 2B also updates the mapping data of an external VOL 42 which has been used to form a pair (for example, by performing processing similar to that of S37 in FIG. 6) (S62).

Then, processing similar to that of S20 through S22 in FIG. 5 is performed (S63 through S65).

The above is the second connection processing flow. In this second connection processing also, upon connection to the first storage control apparatus 20 in S41, the second storage control apparatus 40 may transmit configuration information and mapping data for each external VOL, without receiving an inquiry command or read command from the first storage control apparatus 20. Moreover, the judgment processing of S47 may be performed between a YES result in S44 and S45.

(D) Second Data Processing

This second data processing can for example be executed after the second connection processing explained in FIG. 7 and FIG. 8, upon receiving an I/O request from the host apparatus.

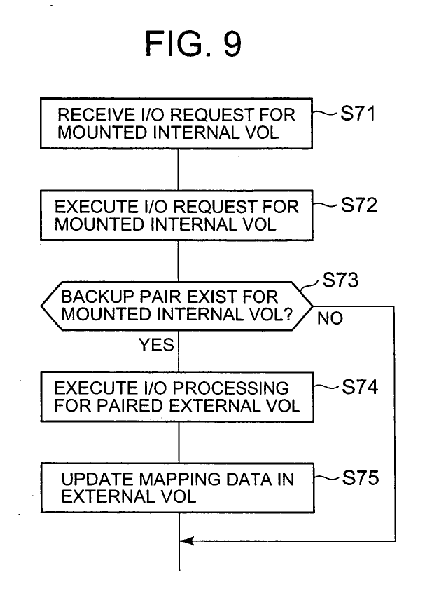

FIG. 9 shows an example of the second flow of data processing.

Upon receiving an I/O request for a mounted internal VOL 31 (S71), the CHA 2A controls the DKA 22 to execute I/O processing for the mounted internal VOL 31 (S72). Also, the CHA 2A references the VOL management table 1 and/or mapping table 102 to judge whether or not there exists a backup pair for the mounted internal VOL 31 (S73). In S73, if an address association record comprising the address of the mounted internal VOL 31 is found, and/or if an external VOL is detected as being registered in the VOL management table 1 as paired with the mounted internal VOL 31, then the judgment result is positive.

When a positive judgment result is obtained (YES in S73), the CHA 2A causes the CHA 2B to execute I/O processing of the external VOL 42 which is the paired VOL (S74). The CHA 2B updates the mapping data 47 in the external VOL 42 (for example, the final access time in the mapping body sub-data 48 comprising the mounted internal VOL address) (S75).

When the result in S73 is NO, the second data processing may be ended.

The above is an explanation of the first embodiment. In this first embodiment, the data size of the control sub-data 49 can be made constant, and moreover the data size of the mapping body sub-data 48 can also be made constant. In this case, the CHA 2B for example first references the control sub-data 49, and based on the number of mapping body sub-data items registered in the control sub-data 49, can control the read range. Specifically, for example, if there is a larger number of mapping body sub-data items registered in the control sub-data 49, the CHA 2B can broaden the read range of mapping body sub-data.

By means of this embodiment, mapping data 47 comprising addresses of internal VOLs (which may be either virtual or mounted) set in the first storage control apparatus 20 is stored by the second storage control apparatus 40. When the second storage control apparatus 40 is connected to the first storage control apparatus 20, the first storage control apparatus 20 receives the mapping data 47 from the second storage control apparatus 40, and using this mapping data 47, automatically associates internal VOL addresses and external VOL addresses. By this means, connection of the second storage control apparatus 40 to the first storage control apparatus 20 can be performed easily.

### Embodiment 2

Next, a second embodiment of the first aspect of the invention is explained. In the following explanation, points of difference with the first embodiment are principally explained, and explanations of points in common are omitted or abbreviated.

In this second embodiment, the size of the mapping table 102 is limited. Specifically, when a certain number of address association records (for example, of constant size) are registered in the mapping table 102, if at least one address association record is not deleted, a new address association record cannot be appended. Hence in this second embodiment, the method explained below is used to delete address association records.

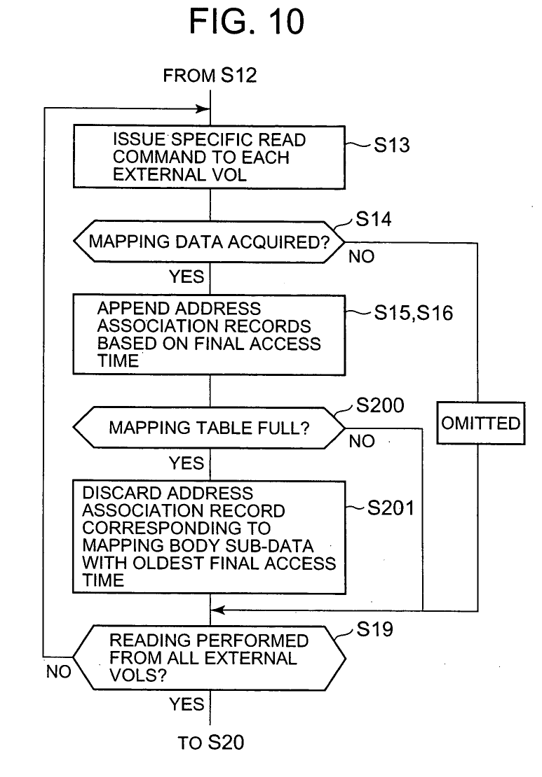

FIG. 10 shows a portion of a flow of connection processing in the second embodiment.

After appending a generated address association record to the mapping table 102, if the mapping table 102 is full (YES in S200), the CHA 2B deletes from the mapping table 102 the address association record corresponding to the mapping body sub-data 48 with the oldest final access time (S201). Whether the mapping table 102 is full or not can for example be judged by whether the number of address association records has reached a prescribed upper limit (registered for example in a prescribed storage area of shared memory 25 or similar).

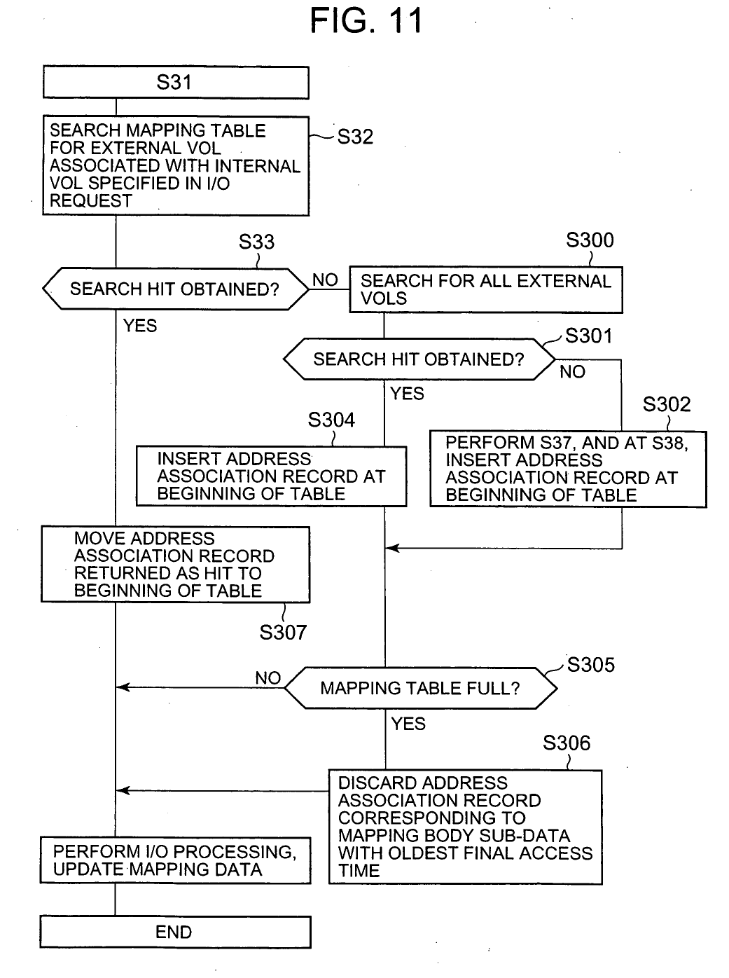

FIG. 11 shows a portion of a flow of data processing in the second embodiment.

When the result of S33 is YES, the CHA 2A moves the address association record resulting in a search hit to the beginning of the mapping table 102 (S307). That is, in this second embodiment, address association records correspond to mapping body sub-data items with older final access times in moving from the beginning toward the end of the mapping table 102.

When the result of S33 is NO, the CHA 2B issues a read command to all external VOLs, acquires one or more mapping data items 47, and performs a search for the internal VOL address specified in S32 from among the acquired mapping data items 47 (S301).

In S301, if there are no search hits (NO in S301), the CHA 2B generates mapping body sub-data comprising the specified internal VOL address and writes the sub-data to an external VOL selected from among unused external VOLs, and moreover uses the sub-data to generate an address association record, and inserts the generated address association record at the beginning of the mapping table 102 (S302). After the CHA 2B has inserted the newly generated address association record into the mapping table 102, if the mapping table 102 is full (YES in S305), the address association record corresponding to the mapping body sub-data 48 with the oldest final access time is deleted from the mapping table 102 (S306).

If in S301 there is a search hit (YES in S301), the CHA 2B uses the mapping body sub-data in the mapping data of the hit to generate an address association record, and inserts the newly generated address association record at the beginning of the mapping table 102 (S304). After inserting the newly generated address association record into the mapping table 102, if the mapping table 102 is full (YES in S305), the CHA 2B deletes the address association record corresponding to the mapping body sub-data 38 with the oldest final access time from the mapping table 102 (S306).

If in S305 the result is NO, the CHA 2B performs I/O processing for the external VOL having the external address associated with the above specified internal VOL address, and moreover updates the mapping data 47 in the external VOL.

By means of this second embodiment, expansion of the size of the mapping table 102 can be suppressed, and so economization of memory capacity is possible.

### Embodiment 3

In a third embodiment, a storage system 100 comprising a first storage control apparatus 20 and second storage control apparatus 40 is an open-systems type system. For example, the first storage control apparatus 20 can communication according to the SCSI protocol with the second storage control apparatus 40. The communication networks CN1 through CN3 can each be made a LAN (Local Area Network) or a SAN (Storage Area Network).

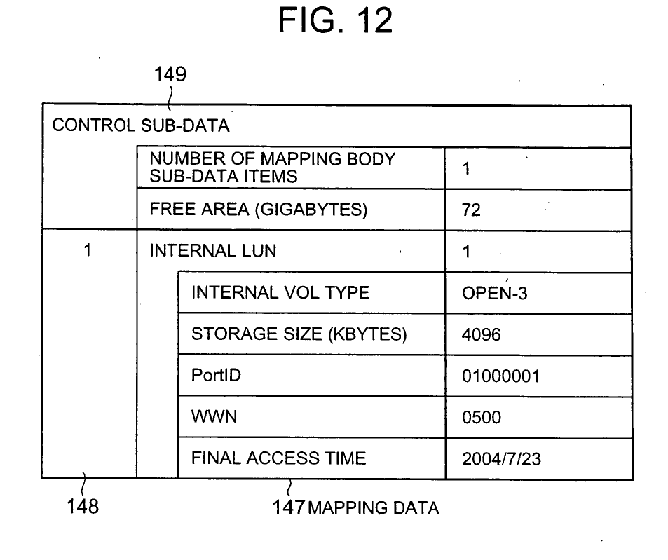

In this third embodiment, the mapping data can be configured as in the example of FIG. 12. That is, in the control sub-data 149 comprising the mapping data 147, the external VOL storage size can be expressed in bytes (and similarly for the internal VOL storage size). Further, in the mapping body sub-data 148, the internal VOL address can be represented as a combination of a LUN (Logical Unit Number), the ID of the port 21B of CHA 2B, and the WWN (World Wide Name) of CHA 2B (in other words, information identifying the path to the internal VOl from the second storage control apparatus).

### Embodiment 4

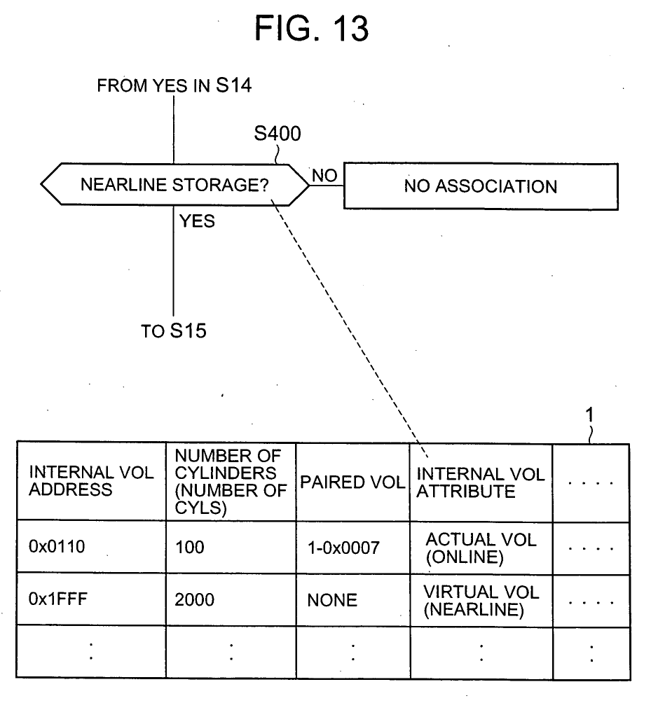

In a fourth embodiment, the first storage control apparatus 20 (for example CHA 2B) can execute control to judge whether at least either one of an internal VOL and an external VOL is nearline storage, and if not nearline storage, to cause an address association record not to be generated. This judgment can for example be performed, as in the example of FIG. 13, between the YES of S14 and S15 (S400).

In this fourth embodiment, the CHA 2B (or 2A) receives input from the SVP 23 or management server 24 specifying an internal VOL and indicating that the specified internal VOL is nearline storage, and based on this specification and input, registers information in the VOL management table 1 indicating whether or not each internal VOL is nearline storage. In this case, the CHA 2B can execute processing to judge, by referencing the VOL management table 1, whether an internal VOL having an internal VOL address in a received mapping table 47 is nearline storage, and if nearline storage, to generate an address association record and append the record to the mapping table 102, but if not nearline storage, to not generate an address association record, and to increment the count of the number of unused external VOLs. Information indicating whether the VOL is nearline storage or not may be registered in either the control sub-data or in the mapping body sub-data of the mapping data 47.

Here, “nearline” means for example that the access frequency is lower than a prescribed value. Storage with an access frequency higher than nearline storage is for example “online” storage. For example, in online storage, access occurs on the order of one-thousandth of one second, whereas in nearline storage, access occurs on the order of seconds.

By generating an address association record only in cases of nearline storage, external VOLs are mapped only to nearly internal VOLs, and external VOLs are not mapped to internal VOLs other than these. Consequently when an internal VOL with low access frequency is accessed, the external VOL is also accessed, but when an internal VOL with high access frequency is accessed, there is no accessing of an external VOL. As a result, when there is coexistence of nearline internal VOLs and internal VOLs with a higher access frequency in a storage control apparatus, degradation of processing efficiency for internal VOLs with higher access frequency can be suppressed.

In this fourth embodiment, the CHA 2B or CHA 2A (or a DKA 22) may manage access frequency (the number of accesses per unit time) for each internal VOL, and when the access frequency is equal to or greater than a prescribed value, may judge the internal VOL not to be nearline storage (or to be online storage), but if the access frequency is less than the prescribed value, may judge the internal VOL to be nearline storage. Further, discrimination of nearline storage may be performed according to the type of internal VOL. The type can for example be registered in the VOL management table 1 or similar. Types which signify nearline storage could be, for example, SATA (Serial ATA) or SAS (Serial Attached SCSI) storage; types which signify other than nearline storage could be, for example, FC (Fiber Channel) media.

In the above, a number of preferred embodiments of the invention have been explained, but these are illustrations used for explanatory purposes, and the scope of the invention is not limited to these embodiments. This invention can be implemented with various other modifications.

What is claimed is:

1. A storage control apparatus, which can be connected to a host apparatus which transmits write/read commands which are write commands or read commands, and to an external storage control apparatus having an external storage device, wherein
said external storage control apparatus stores address information representing at least either one of an external address which is an address of an external storage device and an internal address which is an address of an internal storage device set in said storage control apparatus, and which transmits said stored address information to said storage control apparatus;
said storage control apparatus comprises a storage resource and a control portion; and,
said control portion receives said address information from said external storage control apparatus, generates address association information in said storage resource representing an association between an internal address and an external address based on said received address information, receives said write/read command from said host apparatus, by referencing address association information in said storage resource, identifies the external address associated with said internal address, and when the access target according to said write/read command is said associated internal address, writes data to said identified external address, or reads data from said identified external address and transmits the read data to said host apparatus.

2. The storage control apparatus according to claim 1, wherein
said address information comprises internal address information representing said internal address and is stored in said external storage device; and
said control portion receives address information read from said external storage device and generates address association information representing the association between the external address of said external storage device and the internal address represented by the internal address information in said received address information.

3. The storage control apparatus according to claim 1, wherein
said control apparatus can be connected to one or more external storage control apparatuses;
said one or more external storage control apparatuses comprise a plurality of external storage devices;
said storage resource stores internal device information representing a plurality of internal addresses corresponding to said plurality of storage devices; and,
said control portion:
inputs external device information to identify a plurality of external addresses corresponding to a plurality of external storage devices, and writes said information to said storage resource;
based on said external device information and said address information, causes information to be stored in said storage resource indicating which among said plurality of external addresses are unused external addresses not associated with an internal address;
based on said internal device information and said address information, causes information to be stored in said storage resource indicating which among said plurality of internal addresses are unused internal addresses not associated with an external address;
upon receiving from said host apparatus said write/read command the access target of which is an unused internal address stored in said storage resource, selects at least one external address from among one or more unused external addresses stored in said storage resource, and accesses the selected external address; and,
generates, in said storage resource, address association information representing the association between said selected external address, and the unused internal address which is said access target.

4. The storage control apparatus according to claim 1, wherein said storage control apparatus comprises an internal storage device with a physical presence, and said control portion:
when associating an internal address and external address based on said received address information, if the internal address is an address of said internal storage device with a physical presence, generates, in said storage resource, device association information representing the association between said internal storage device and said external storage device; and,
based on device association information generated in said storage resource, writes data written in said internal storage device with a physical presence to the external storage device associated with said internal storage device with a physical presence, or, writes data written in said external storage device to said internal storage device with a physical presence associated with the external storage device.

5. The storage control apparatus according to claim 4, wherein
said address information comprises external storage capacity information representing the storage capacity of said external storage device and internal storage capacity information representing the storage capacity of said internal storage device with a physical presence; and
when the storage capacity represented by external storage capacity information in said received address information is greater than or equal to the storage capacity represented by said internal storage capacity information, said control portion generates said device association information.

6. The storage control apparatus according to claim 4, wherein
said address information comprises internal address information representing an internal address;
said storage resource stores separate internal address information representing an internal address of said storage device with a physical presence; and
when the internal address information comprised by said received address information does not agree with said separate internal address information, said control portion sets a virtual internal storage device based on said internal address information; and
said control portion presents to said host apparatus, as internal storage devices of said storage control apparatus, both said set virtual internal storage devices, and said internal storage devices with a physical presence.

7. The storage control apparatus according to claim 1, wherein said address information comprises final access time information representing the time of final access of at least either one of the external address and the internal address;
said control portion, when writing data to said identified external address, or when reading data from the identified external address and transmitting the data to said host apparatus, updates the final access time information comprised by the address information corresponding to the external address; and
said control portion deletes the address association information corresponding to the address information with the oldest time represented by said final access time from among said plurality of address association information items stored in said storage resource.

8. The storage control apparatus according to claim 1, wherein
said address information comprises a plurality of internal address information items representing a plurality of internal addresses; and
said control portion associates a plurality of internal addresses, representing a plurality of internal address information items in said received address information, with the same external address, and generates address association information representing these associations in said storage resource.

9. The storage control apparatus according to claim 1, wherein
said external storage control apparatus stores a plurality of address information items comprising information representing the same internal address; and
said control portion, upon receiving said plurality of address information items, generates in said storage resource address association information representing the associations between the same internal address and a plurality of external addresses.

10. The storage control apparatus according to claim 1, wherein
said control portion judges whether an internal storage device or an external storage device has an access frequency lower than a prescribed value; and
when the judgement result is positive, generates address association information representing an association between an internal address of the internal storage device and an external address of the external storage device.

11. A storage control method, realized in a storage control apparatus which can be connected to a host apparatus which transmits write/read commands which are write commands or read commands, and to an external storage control apparatus having an external storage device, wherein said external storage control apparatus stores address information representing at least either one of an external address which is an address of an external storage device and an internal address which is an address of an internal storage device set in said storage control apparatus, and transmits said stored address information to said storage control apparatus,
said method comprising the steps of:
receiving said address information from said external storage control apparatus;
generating in said storage resource address association information representing an association between an internal address and an external address, based on said received address information;
receiving said write/read command from said host apparatus, and by referencing address association information in said storage resource, identifying the external address associated with said internal address; and,
when an access target according to said write/read command is said associated internal address, writing data to said identified external address, or reading data from said identified external address and transmitting the data to said host apparatus.
